(19) United States
(12) Patent Application Publication
(10) Pub. No.: US 2008/0309588 A1
(43) Pub. Date: Dec. 18, 2008

(54) Head mount display

(75) Inventors: Nobuyuki Miyake, Hiratuka-shi (JP); Kenzo Chiaki, Kawasaki-shi (JP)

Correspondence Address: OLIFF & BERRIDGE, PLC, P.O. BOX 320850, ALEXANDRIA, VA, 22320-4850, US

(73) Assignee: NIKON CORPORATION, Tokyo (JP)

(21) Appl. No.: 12/222,428

(22) Filed: Aug. 8, 2008

Related U.S. Application Data
(63) Continuation of application No. PCT/JP2007/054339, filed on Mar. 6, 2007.

(30) Foreign Application Priority Data
Mar. 10, 2006 (JP) 2006-065132

(51) Int. Cl. G09G 5/00

(52) U.S. Cl. 345/8

(57) ABSTRACT

A head mount display having a display part rotatable relative to a head mount part, in which, when the display part is rotated and retreated from in front of the eyes to the top of the head of the wearer when not is use, the display part is less possible to come into contact with the forehead or hair of the wearer during its rotation. The head mount display has an arm part at the forward end of which the display part is mounted and mounting parts for fitting the other end of the arm part to the head mount part. The other end of the arm is mounted by the mounting parts to the head mounting part so as to be rotatable in the direction where the forward end of the arm part is separated from the mounting parts and so as to be displaceable in the direction.

### TECHNICAL FIELD

The present invention relates to a head mounted display for displaying an image in front of one or each eye of a user.

### BACKGROUND ART

There is disclosed a head mounted display as a device for displaying an image in front of one or each eye of a user. A conventional head mounted display is equipped with an arm having a display part on the forward end thereof in such a manner that the arm is rotatable relative to the head mounted part that is to be mounted on the user's head (e.g., see Patent document 1). This kind of head mounted display features that the display part, not in use, is rotated and put away from the position in front of the eye, up to the overhead location of the user (hereinafter, such rotating operation for putting away is referred to as “rotational retraction”).

[Patent document 1]

Japanese Patent Laid-open Publication No. 2004-78057

### DISCLOSURE OF THE INVENTION

### Problem to be solved by the Invention

The conventional head mounted display has a problem that when the arm is rotationally retracted toward the overhead location, the display part is more likely to touch the user's face area, such as the user's forehead and hair, during the rotation of the display part. Therefore, this may not only deteriorate the usability, but also cause smudges or scratches on a display surface of the display part.

The present invention has been made in view of the problems found in the conventional art as described above, and an object of the present invention is to provide a head mounted display having a display part that is movable rotationally relative to the head mounted part, which enhances usability when retracting the display part not in use, from the position in front of an eye up to the overhead location, and thereby avoiding that the surface of the display part becomes smudged, or the like.

### Means to Solve the Problem

A head mounted display of a first aspect of the present invention to solve the problems above, includes, a head mounted part wearable on a head, an arm part having a display part installed on one end, an installation part for installing the other end of the arm part rotatably relative to the head mounted part, characterized in that the installation part installs the other end of the arm part in such a manner that the one end of the arm part is subjected to displacement, in the direction getting away from the installation part, or in the direction getting away from a user's eye position in the user's face width direction.

The head mounted display of a second aspect of the present invention according to the head mounted display of the first aspect is characterized in that the installation part installs the other end of the arm part on the head mounted part, in such a manner that after the one end of the arm part is subjected to the displacement in the direction getting away, the arm part performs rotation relative to the head mounted part, so as to retract the display part up to a position opposed to the head mounted part.

The head mounted display of a third aspect of the present invention according to the head mounted display of the first aspect is characterized in that the installation part installs the other end of the arm part on the head mounted part, in such a manner that the one end of the arm part performs the rotation, while subjected to the displacement in the direction getting away, so as to retract the display part up to a position opposed to the head mounted part.

The head mounted display of a fourth aspect of the present invention according to the head mounted display of the first aspect is characterized in that the installation part installs the other end of the arm part on the head mounted part, in such a manner that after the one end of the arm part is subjected to the displacement in the direction getting away from the position of the user's eye in the face width direction of the user, the arm part performs the rotation relative to the head mounted part, so as to retract the display part up to a position opposed to the head mounted part.

The head mounted display of a fifth aspect of the present invention according to the head mounted display of any one of the second aspect to the fourth aspect is characterized in that a cam follower is formed on the other end side of the arm part, and the installation part has a cam being formed therein to be engaged with the cam follower for guiding the displacement and the rotation.

The head mounted display of a sixth aspect of the present invention according to the head mounted display of any one of the first aspect to the fifth aspect, includes a sensor for detecting a predetermined motion of the arm part and outputting a signal for turning off the head mounted display power supply, characterized in that the sensor outputs the signal when the sensor detects that the arm part displaces the display part in the direction getting away from the installation part, or in the direction getting away from the user's eye position in the user's face width direction.

The head mounted display of a seventh aspect of the present invention according to the head mounted display of any one of the first aspect to the sixth aspect is characterized in that the rotation and displacement of the arm part are performed to be symmetric with respect to a plane defined by the head mounted part.

### Effect of the Invention

According to the present invention, when the display part not in use is retracted from the position in front of the eye up to the overhead location, the display part can be moved from the position in front of the eye up to the retracted position without touching the forehead and hair during the rotation. Consequently, it is possible to enhance the usability, as well as avoiding smudges on the surface of the display part, or the like.

### BRIEF DESCRIPTION OF DRAWINGS

FIG. 1 is a perspective view of the head mounted display 10 according to a first embodiment of the invention;

FIG. 2 is a cross sectional view on line II-II in FIG. 1;

FIG. 3 is a cross sectional view on line III-III in FIG. 1;

FIG. 4 illustrates an ear pad viewed from the direction of the support part according to the first embodiment;

FIG. 5 is a cross sectional view on line V-V in FIG. 1;

FIG. 6 illustrates an image indicating a positional relationship between the movement of the display part and the head of the user, according to the first embodiment;

FIG. 7 is a perspective view of the head mounted display according to a modified example of the first embodiment;

FIG. 8 illustrates an ear pad viewed from the direction of the support part according to the modified example of the first embodiment;

FIG. 9 illustrates an image indicating a positional relationship between the movement of the display part and the head of the user, according to the modified example of the first embodiment;

FIG. 10 is a perspective view of the head mounted display according to a second embodiment of the invention;

FIG. 11 is a cross sectional view on line XI-XI in FIG. 10;

FIG. 12 illustrates the installation part 8 viewed from the arrow XII in FIG. 10;

FIG. 13 illustrates an image indicating a positional relationship between the movement of the display part and the head of the user, according to the second embodiment;

FIG. 14 is a perspective view of the head mounted display according to a modified example of the second embodiment;

FIG. 15 is an illustration of the installation part 8 viewed from the arrow XV in FIG. 14; and

FIG. 16 is a cross sectional view on line III-III of FIG. 1 according to the modified example.

### Denotation of Reference Numerals

1: DISPLAY PART, 2: ARM PART, 3: SUPPORT PART, 4a: EAR PAD, 4b: EAR PAD, 5: HEAD MOUNTED PART, 6: SENSOR, 10: HEAD MOUNTED DISPLAY, 20: HEAD MOUNTED DISPLAY

### BEST MODE FOR CARRYING OUT THE INVENTION

Hereinafter, there will be explained embodiments to which the present invention is applied, with reference to the accompanying drawings.

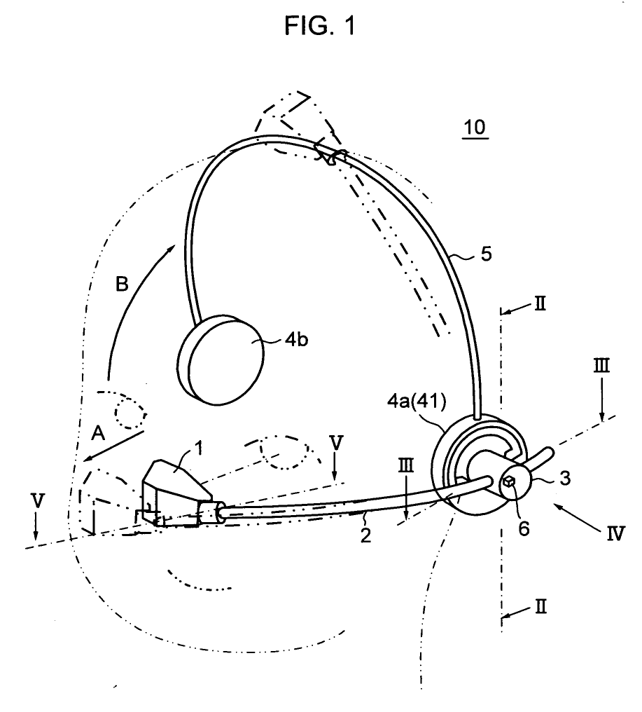

FIG. 1 is a perspective view of the head mounted display 10 according to the first embodiment of the present invention. As illustrated, the head mounted display 10 is provided with a display part 1, an arm part 2, a support part 3, two ear pads 4a and 4b, a head mounted part 5. The support part incorporates a sensor 6 for detecting motion of the arm part 2.

The head mounted display 10 according to the present embodiment is used by placing the ear pads 4a and 4b respectively on the left and right ears and adjusting the arm part 2 so that the display part 1 is arranged just in front of the left eye.

The head mounted part 5 according to the present embodiment is made of a material having a predetermined elasticity. The ear pads 4a and 4b are formed on both ends of the head mounted part 5 in the longitudinal direction. A distance between the ear pads 4a and 4b is made smaller than the width of the user's head, thereby allowing the ear pads 4a and 4b provided on the both ends of the head mounted part 5 to be urged inwardly relative to the user's head, so that the head mounted display 10 is mounted fixedly on the user's head when the user wears the head mounted display.

In addition, the support part 3 is rotatably coupled with the enclosure 41 of the ear pad 4a.

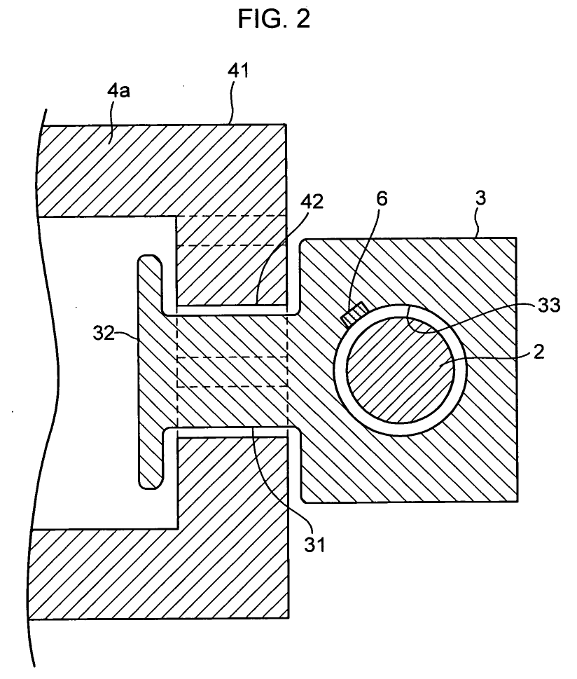

FIG. 2 is a cross sectional view on line II-II in FIG. 1. As is shown, the support part 3 is provided with a columnar axial member 31. The axial member 31 is inserted into a columnar through-hole 42 provided on the enclosure 41 of the ear pad 4a, whereby the support part 3 is rotatably coupled with the enclosure 41.

In order to prevent the support part 3 from being detached from the enclosure 41, a flange 32 is provided on the tip of the axial member 31 within the enclosure 41. In addition, the inner diameter of the through-hole 42 and the outer diameter of the axial member 31 are appropriately designed so that a predetermined friction torque is generated between the through-hole 42 and the axial member 31. It is further possible to place a frictional member so as to generate the friction torque between the through-hole 42 and the axial member 31.

The arm part 2 is slidably coupled with the support part 3.

As shown in FIG. 2, the support part 3 is provided with a columnar through-hole 33. The arm part 2 is slidably coupled with the support part 3 by allowing the columnar arm part 2 to pass through the through-hole 33.

The inner diameter of the through-hole 33 and the outer diameter of the arm part 2 are appropriately designed so that a predetermined friction torque is generated between the through-hole 33 and the arm part 2. Since the support part 3 is rotatable relative to the enclosure 41, not only the arm part slides in the support part 3, but also it is rotatable together with the support part 3, using the axial member 31 of the support part 3 as a rotation axis. This rotating motion and sliding motion of the arm part 2 are combined to retract the display part 1 installed on the forward end, up to a position opposed to the head mounted part 5. Hereinafter, the position where the display part 1 is opposed to the head mounted part 5 is referred to as “retracted position”. In the present embodiment, the support part 3, and the enclosure 41 of the ear pad 4a constitute an installation part for installing one end of the arm part 2 on the head mounted part 5.

When the head mounted part 5 is mounted on the head, the arm part 2 is curved centering on the user's head side, in such a manner that the display part 1 installed on the forward end of the arm part 2 is positioned in front of the user's eye on the ear pad 4a side.

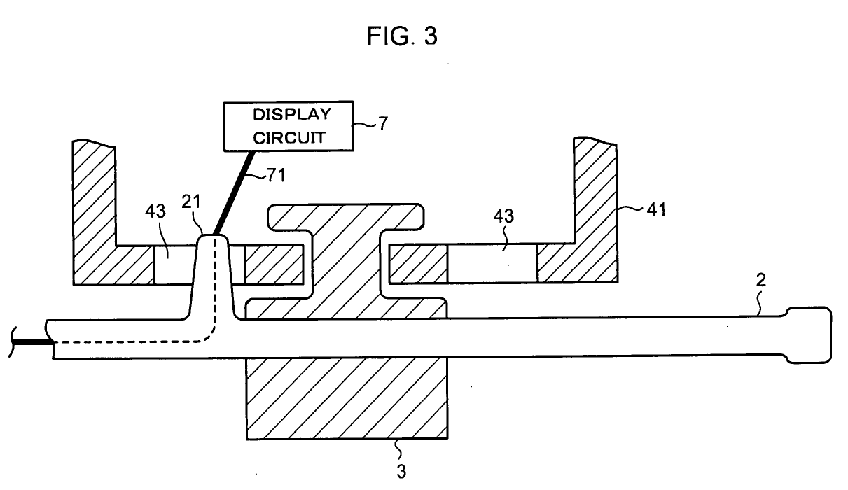

Next, there will be explained a relationship between the arm part 2 and the ear pad 4a. FIG. 3 is a cross sectional view on line III-III in FIG. 1.

The arm part 2 is provided with a cam follower 21 in a form of protrusion. The cam follower is provided so as to be engaged with a cam groove 43 that is installed in the ear pad 4a, which will be described below. A wall plate on the support part side of the enclosure 41 of the ear pad 4a is provided with a through-hole serving as the cam groove 43. This cam groove 43 is engaged with the cam follower 21 of the arm part 2, thereby guiding the movement of the arm part 2. Here, the reference numeral 71 indicates a signal line to supply a video signal and power supply from a display circuit 7, which will be described below, via the arm part 2 to the display part 1.

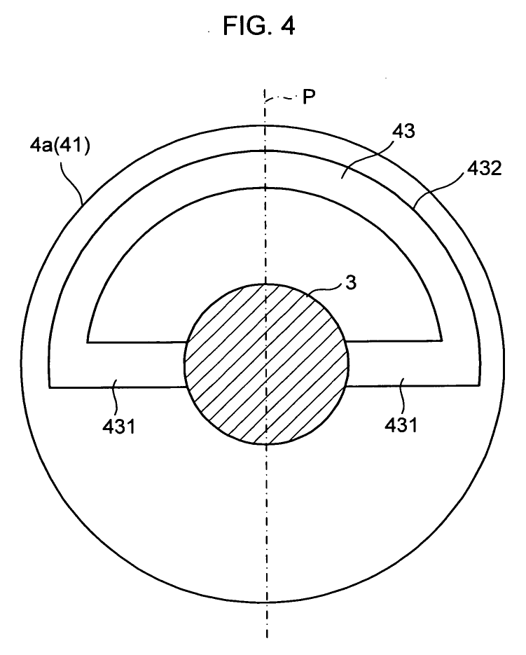

FIG. 4 illustrates the ear pad 4a viewed from the direction of the arrow IV in FIG. 1. As illustrated, the cam groove 43 is provided with a slide groove portion 431 extending in the direction getting away from the rotation center of the support part 3, and a rotation groove portion 432 being a circular arc shape, setting the support part 3 as a rotation center. The rotation groove portion 432 and the slide groove portion 431 are provided in a continuous manner. This cam groove 43 is symmetrical with respect to a virtual plane P including the rotation center of the support part 3 and the head mounted band 5. It is configured in such a symmetrical form so that the display part 1 is allowed to be positioned in front of any of the either eyes, left or right, as described below.

The head mounted display 10 according to the present embodiment is used in the state where the cam follower 21 of the arm part 2 is engaged with the slide groove portion 431. Therefore, the slide groove portion 431 is provided so that the display part can be placed at a position approximately equal to the height of the user's eye, when the head mounted display is in use. Therefore, the arm part 2 is slidable according to the guide of the slide groove portion 431, from the position being in use, in the near-far direction relative to the support part 3.

It is to be noted that the slide groove portion 431 is provided for the purpose that the arm part is moved so as to avoid touching the user's face area, such as the forehead and hair, when the display part 1 installed on the forward end of the arm part 2 is moved rotationally about the axial member 31. Therefore, the slide groove portion is formed in a length to achieve this purpose. The radius of the ear pad 4a is also set to be a length that makes this purpose achievable.

Hereinabove, there has been explained a relationship among the arm part 2, the ear pad 4a, and the support part 3.

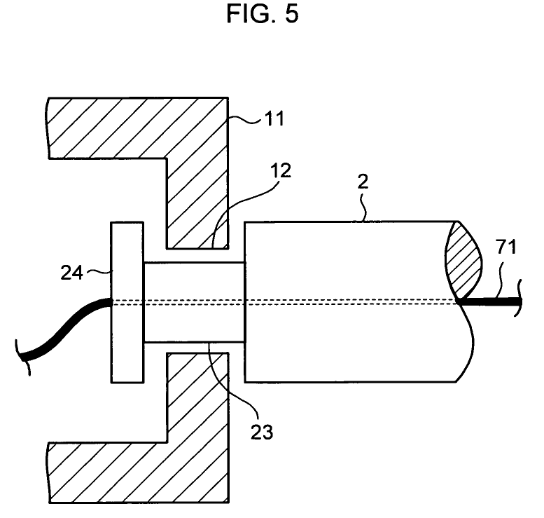

The display part 1 is rotatably coupled with the forward end of the arm part 2. FIG. 5 is a cross sectional view on line V-V in FIG. 1. As illustrated, an enclosure 11 of the display part 1 is provided with a columnar through-hole 12 on the joint with the arm part 2. A columnar axial member 23 provided on the tip of the arm part 2 is inserted into the through-hole 12, thereby coupling the enclosure 11 of the display part 1 rotatably with the arm part 2. An axis line of the axial member 23 is parallel to the longitudinal direction of the arm part 2. The configuration above allows the display part 1 to be rotatable using the arm part 2 as an axis.

In order to prevent the arm part 2 from being detached from the enclosure 11, a flange 24 is provided on the tip of the axial member 23 within the enclosure 11. In addition, the inner diameter of the through-hole 12 and the outer diameter of the axial member 23 are appropriately designed so that a predetermined friction torque is generated between the through-hole 12 and the axial member 23. It is further possible to place a frictional member between the through-hole 12 and the axial member 23, so as to generate the predetermined friction torque.

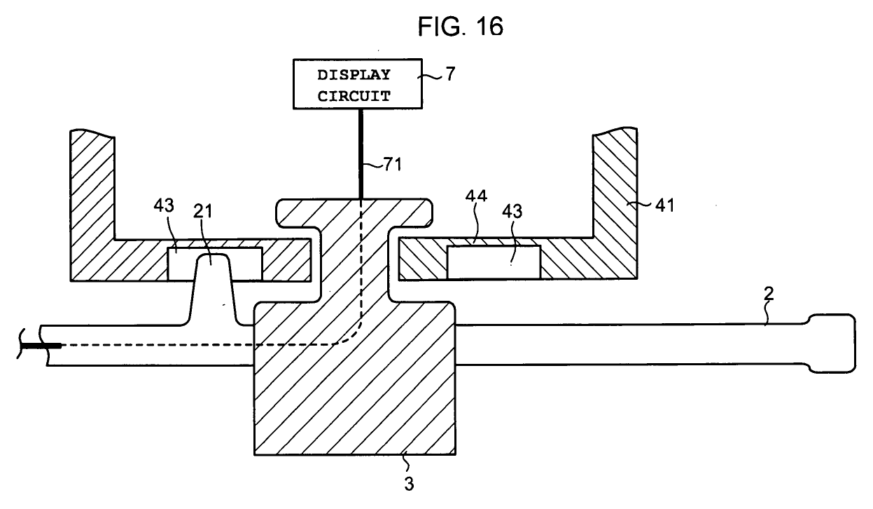

In addition, the head mounted display 10 according to the present embodiment is provided with a display circuit for generating a video signal to be displayed in the display part 1. As shown in FIG. 3 and FIG. 16, the enclosure 41 of the ear pad 4a on the observer's right side in FIG. 1 incorporates the display circuit 7. The display circuit 7 generates an image signal according to a directive accepted by a controller (not illustrated) that is provided for accepting the directive from the user. Then, the display circuit 7 supplies the display part 1 with the image signal being generated and power supply, via the signal line 71 disposed within the arm part 2. As described above, the signal line 71 is installed in the arm part 2 through the cam follower 21 from the inside of the enclosure 41 of the ear pad 4a. The image signal supplied to the display part 1 is displayed as an image in the display device provided in the display part 1.

The display circuit 7 is further provided with an image inverting circuit for inverting the image supplied to the display part 1 according to a directive from the controller. This circuit is provided so that the image is presented in a proper orientation, when the display part 1 is arranged at any of the positions; in front of the right eye or the left eye.

As shown in FIG. 2, the through-hole 33 in the support part 3 is equipped with a sensor 6 for detecting that the arm part 2 has moved in the direction that allows the display part 1 installed on the forward end of the arm part to go away from the support part 3. Since an already-existing sensor being capable of detecting an object's shift is used as the sensor 6, detailed explanations will not be made here. When the sensor 6 detects that the arm part 2 has moved beyond a predetermined fine-tuning range, along the slide groove 431, the sensor 6 outputs a power OFF signal to the display circuit 7. Upon receipt of the power OFF signal, the display circuit 7 turns the power off.

It is to be noted here that the sensor 6 is provided just for outputting a signal to turn the power off, and therefore it is not necessarily provided. It is sufficient to provide another configuration only, in which the user inputs a directive of power-off via the operation part of the controller.

It is further possible to configure such that the display circuit 7 is capable of processing an audio signal, using the ear pads 4a and 4b as speakers for outputting the audio signal.

Next, there will be explained a usage example of the head mounted display 10 having the configuration above according to the present embodiment.

When the head mounted display 10 according to the present embodiment is used, the head mounted part is mounted on the user's head in such a manner that the ear pads 4a and 4b are placed on the user's ears. Then, the cam follower 21 of the arm part 2 is made to slide within the slide groove 431, thereby allowing the arm part 2 to slide so that the display part 1 is adjusted to be positioned in front of the user's eye. On this occasion, it is further possible that the display part 1 itself is moved rotationally relative to the arm part 2, and an angle of the display surface of the display part 1 is adjusted.

When an image-reproducing directive is accepted from the user via the operation part of the controller, the display circuit 7 supplies the image signal being generated and displays an image.

It is to be noted that in FIG. 1, the display part 1 is positioned in front of the user's left eye, and the ear pad 4a is placed on the left ear. When the head mounted display 10 according to the present embodiment is mounted in such a manner that the display part 1 is rotated together with the arm part 2 along the cam groove 43, by approximately 180 degrees around the support part 3 and the ear pad 4a is placed on the right ear, the display part 1 is allowed to be placed in front of the user's right eye. In this case, it is necessary that the image displayed in the display part 1 is inverted vertically. In the present embodiment, an inverting directive is accepted from the user via the operation part of the controller, and image signals are generated for an image which is inverted by the display inverting circuit of the display circuit 7. It is further possible to configure such that a sensor is provided within the support part 3 or in the ear pad 4a for detecting a position of the arm part 2, thereby deciding top and bottom of the image to be displayed in the display part 1, according to the position of the arm part 2.

When viewing the image by the head mounted display 10 is finished, the user applies a force to the arm part 2 so that the display part 1 is directed to the retracted position, so as to place the display part 1 to the retracted position. In the head mounted display 10 of the present embodiment, the movement of the arm part 2 is restricted by the cam groove 43 provided in the ear pad 4a and the cam follower 21 of the arm part 2, since the cam follower 21 of the arm part 2 is engaged with the cam groove 43.

When in use (when viewing the image), the cam follower 21 is placed within the slide groove portion 431 as described above. Upon receipt of a force from the user, the cam follower 21 of the arm part 2 slides along the slide groove portion 431, and moves the display part 1 together with the arm part 2 in the direction going away from the support part 3 (in the direction of arrow A in FIG. 1). In addition, when the cam follower 21 reaches the end of the slide groove portion 431, the cam follower 21 slides along the rotation groove portion 432, rotates the display part 1 together with the arm part 2 toward the head mounted part 5 (in the direction of arrow B in FIG. 1), to guide the display part 1 to the retracted position.

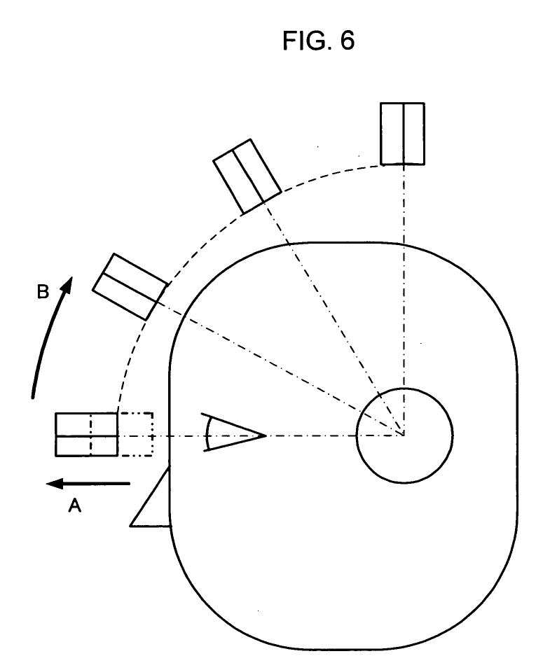

FIG. 6 illustrates an image indicating a positional relationship between the movement of the display part 1 and the head of the user. The movements indicated by the arrows A and B are respectively associated with those in FIG. 1. The display part 1 installed on the forward end of the arm part 2 moves in the direction going away from the support part 3 (in the direction indicated by the arrow A), and rotates about the axial member 31 of the support part 3 (in the direction indicated by the arrow B).

When the cam follower 21 of the arm part 2 starts sliding along the slide groove portion 431, the sensor 6 detects the sliding motion and outputs a power OFF signal to the display circuit 7. The display circuit 7 receives the power OFF signal, and turns the power off.

According to the head mounted display 10 of the present embodiment as discussed above, when the user finishes viewing the image and retracts the display part 1 together with the arm part 2 to the retracted position, the movement of the arm part 2 is restricted by the cam follower 21 and the cam groove 43 as described above, and accordingly, the movement of the display part 1 installed on the forward end of the arm part 2 is restricted as well. Therefore, a turning radius becomes larger than a conventional art, when the user finishes viewing the image and retracts the arm part 2 and the display part 1 up to the overhead location, reducing the likelihood that the display part touches the user's face area, such as the forehead and hair. Accordingly, it is also less possible that the display part 1 becomes smudged or damaged upon retraction.

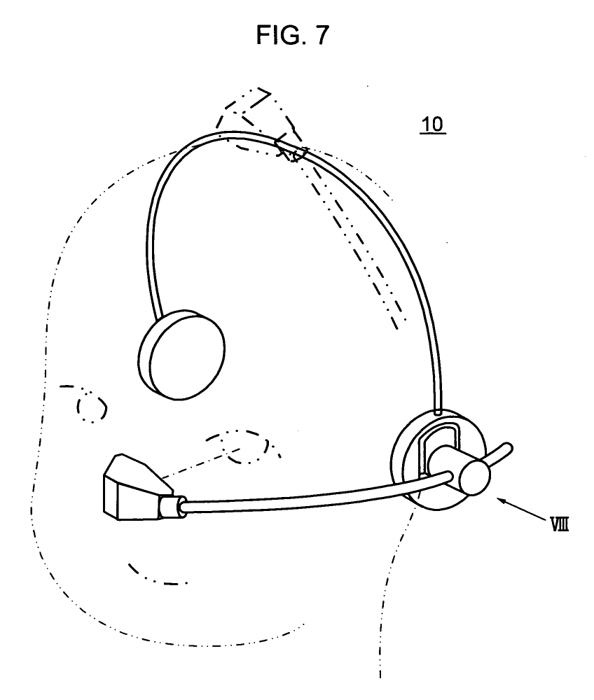

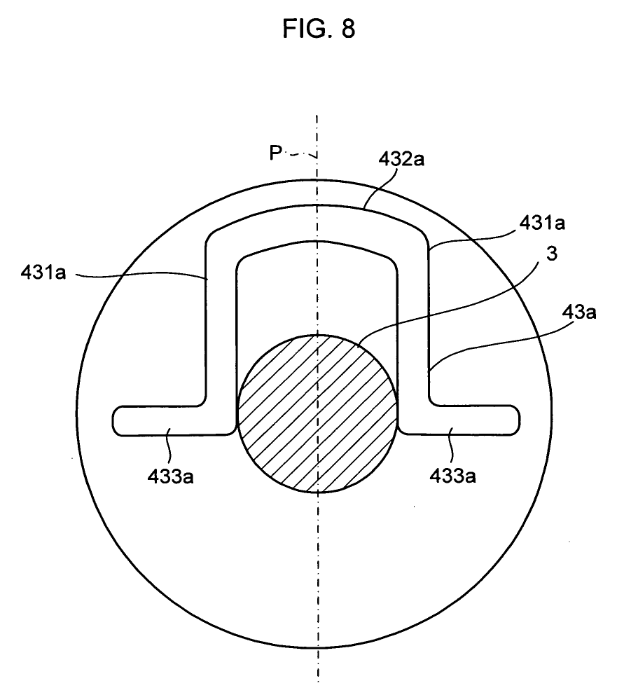

Next, with reference to FIG. 7 and FIG. 8, a modified example of the cam groove 43 according to the present embodiment will be explained. FIG. 7 is a perspective view of the head mounted display 10 according to the modified example. FIG. 8 illustrates the ear pad viewed from VIII in FIG. 7. As illustrated, the cam groove 43a relating to this modified example, is provided with a slide groove portion 431a extending in the direction going away from the rotation center of the support part 3, similar to the above embodiment, a rotation groove portion 432a having a circular arc shape, rotating about the center of the support part 3, and a horizontal slide groove portion 433a. The horizontal slide groove portion 433a is a cam groove for finely tuning the distance between the position of the display part 1 and the eye, when the user mounts and uses the head mounted display 10. The horizontal slide groove portion 433a is provided so that the display part 1 in use is located at a position approximately equal to the height of the user's eye. In addition, the rotation groove portion 432a and the horizontal slide groove portion 433a are respectively provided on both ends of the slide groove 431a in a continuous manner.

The cam groove 43a in this modified example is symmetrical, similar to the aforementioned cam groove 43, with respect to the virtual plane P including the rotation center of the support part 3 and the head mounted band 5. In FIG. 8, the slide groove portion 431a is provided approximately in parallel with this virtual plane P. However, the direction of the slide groove portion 431a is not limited to the one as illustrated. Any direction including a substance parallel to the virtual plane P may be applicable.

In the present modified example, when in use, the cam follower 21 is placed in the horizontal slide groove portion 433a. When the user who finished viewing the image applies a force to allow the arm part 2 directed to the retracted position, the cam follower 21 moves from the horizontal slide groove portion 433a to the slide groove portion 431a, and allows the display part 1 together with the arm part 2 to move to the direction getting away from the support part 3. In addition, when the display part 1 reaches the end of the slide groove 431a, the cam follower 21 slides along the rotation groove 432a, allows the display part 1 together with the arm part 2 to rotate directed to the head mounted part 5, guiding them up to the retracted position.

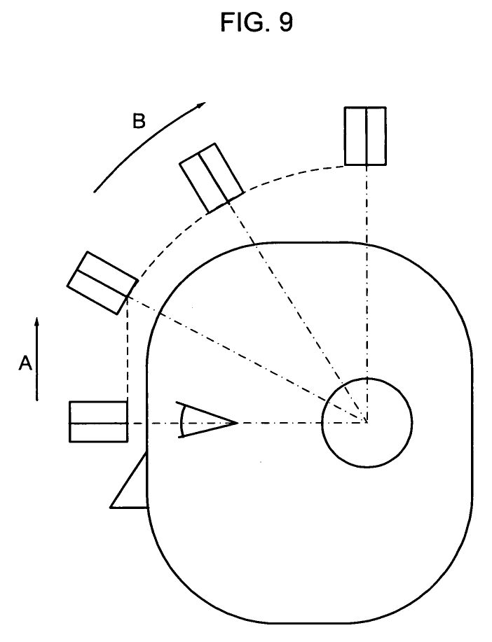

FIG. 9 illustrates an image indicating a positional relationship between the movement of the display part 1 and the head of the user. The display part 1 installed on the forward end of the arm part 2 moves in the direction getting away from the support part 3 (in the direction indicated by the arrow A), and from the moved-up position, the display part 1 rotates about the axial member 31 of the support part 3 (in the direction indicated by the arrow B).

When the cam follower 21 moves along the slide groove portion 431a, this movement allows the cam follower to be in the direction getting away from the rotation center of the support part 3. Therefore, the sensor 6 detects the movement of the arm part 2, and outputs a power OFF signal to the display circuit 7. The display circuit 7 receives the power OFF signal and turns the power off.

According to the head mounted display 10 of the modified example, when the user finishes viewing the image and retracts the display part 1 together with the arm part 2 up to the retracted position, the movement of the arm part 2 is restricted by the cam follower 21 and the cam groove 43a as described above. Accordingly, the movement of the display part 1 installed on the forward end of the arm part 2 is restricted as well. Therefore, when the user finishes viewing the image and retracts the arm part 2 and the display part 1 up to the overhead location, a turning radius becomes larger than a conventional art, reducing the likelihood that the display part 1 touches the user's face area, such as the forehead and hair. Accordingly, it is also less possible that the display part 1 becomes smudged or damaged upon retraction.

It is to be noted here that the shape of the cam groove is not limited to the shape as described in the above embodiment and modified example. Any shape may be available if it allows the display part 1 to move in the direction away from the rotation center of the support part 3 that rotates on the ear pad 4a, before the arm part 2 and the display part 1 start the rotating motion to be moved up to the retracted position. It is further possible to configure such that the display part 1 moves toward the head mounted direction 5 after the display part 1 reaches the retracted position. In the case above, a new cam groove is formed so that the cam follower 21 goes toward the support part 3 after the display part reaches the retracted position.

In the present embodiment, the fine-tuning of the arm part 2 during use is configured such that the arm part is changeable in position only in the direction forming approximately 90 degrees with the virtual plane P. However, this is not the only configuration. It is further possible to configure such that the slide groove 431 is formed in a fan shape opening toward the outer periphery of the ear pad 4a, thereby also allowing vertical fine-tuning.

### Second Embodiment

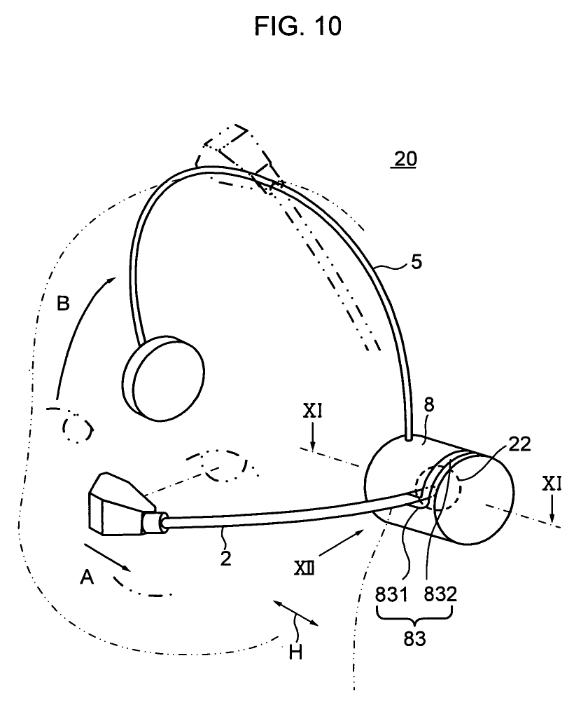

Next, a second embodiment to which the present invention is applied will be explained. FIG. 10 is a perspective view of the head mounted display 20 according to the present embodiment. The head mounted display 20 according to the present embodiment has a configuration basically similar to the first embodiment.

The head mounted display 20 according to the present embodiment is provided with an installation part 8 having both functions of the ear pad 4a and the support part 3 of the first embodiment. The installation part 8 has a columnar shape in FIG. 10, but it is not limited to the columnar shape. In addition, the arm part 2 does not have the cam follower, and it is provided with a spherical body 22 on the end opposite to the end having the display part 1.

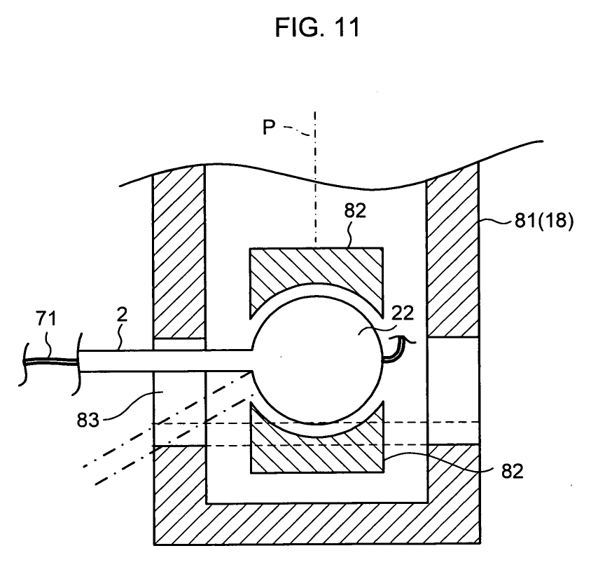

FIG. 11 is a cross sectional view of the installation part 8 on line XI-XI in FIG. 10. The installation part 8 incorporates in its enclosure 81, a ball bearing 82 and a display circuit (not illustrated). The ball bearing 82 rotatably supports the spherical body 22 of the arm part 2.

In addition, the enclosure 81 includes a guide groove 83 formed in a manner penetrating toward inside, and the arm part 2 passes through the guide groove 83 and extends outwardly from the installation part 8. The guide groove 83 regulates the movement of the arm part 2.

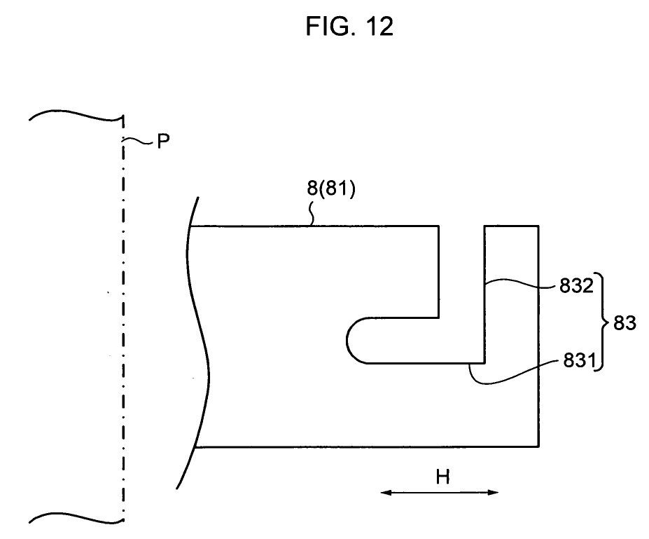

FIG. 12 is an illustration of the installation part 8 viewed from the arrow XII in FIG. 10. The guide groove 83 is made up of a first guide groove portion 831 extending in the user's face width direction H during use, and a second guide groove portion 832 being continuous from the first guide groove portion 831, which extends in the peripheral direction of the columnar enclosure 81 of the installation portion 8. More specifically, the first guide groove portion 831 is formed vertically with respect to the virtual plane P including the head mounted part 5, and along the plane expanding in the face width direction H. The second rotation groove 832 is formed vertically with respect to the virtual plane P, and along the plane expanding in the direction also vertical to the face width direction H.

Further in the present embodiment, the guide groove 83 is formed symmetrical with respect to the virtual plane P, so that the display part 1 can be positioned in front of any of the either eyes, left or right.

In addition, the groove width and the groove shape of the guide groove 83 and the outer diameter of the axial member of the arm part 2 are appropriately designed so that a friction torque is generated between the guide groove 83 and the arm part 2. It is further possible to place a frictional member between the guide groove 83 and the arm part 2 so that a predetermined friction torque is generated therebetween.

In the head mounted display 20, a signal line 71 (shown in FIG. 11) from the display circuit 7 extends from the spherical body 22 of the arm part 2 toward the forward end of the arm part 2.

Furthermore, a sensor for detecting that the arm part 2 has moved along the slide groove portion 832 is installed within the enclosure 81. Similar to the first embodiment, an existing sensor, which detects a movement of an object and outputs a power OFF signal, is used as the sensor. Upon receipt of the power OFF signal from the sensor, the display circuit turns the power off, similar to the first embodiment.

Hereinafter, there will be described an example how to use the head mounted display 20 having the configuration as discussed above.

When the head mounted display 20 is used, the user mounts the head mounted part 5 on the head, in such a manner that the ear pad 4b and the installation part 8 are placed respectively on the user's ears. Then, the forward end of the arm part 2 is rotated along the first guide groove portion 831 using the spherical body 22 of the arm part 2 as a center, shifting the display part 1 in the face width direction H to be positioned in front of the user's eye. On this occasion, it is also possible that the display part 1 itself is rotated about the arm part 2, so as to adjust the angle of the display surface of the display part 1.

Upon receipt of a directive for reconstructing image from the user via the operation part of the controller, the display circuit supplies a generated image signal to the display part 1 and displays an image.

In FIG. 10, the display part 1 is arranged in front of the user's left eye, and the installation part 8 is placed on the left ear. Similar to the first embodiment, it is further possible in the present embodiment that the user mounts the head mounted part 5 in such a manner as rotating the display part 1 together with the arm part 2 by approximately by 180 degrees, along the second guide groove portion 832 of the guide groove 83, and placing the installation part 8 on the right ear, whereby allowing the display part 1 to be arranged in front of the user's right eye. In this case, similar to the first embodiment, an inversion directive is accepted from the user via the operation part of the controller, and the display circuit vertically inverts the image displayed in the display part 1. Also in the present embodiment, it is possible to configure such that a sensor for detecting a position of the arm part 2 is provided in the installation part 8, and top and bottom of the image displayed in the display part 1 is determined according to the position of the arm part 2.

When the user finishes viewing the image by the head mounted display 20, the user applies a force to the arm part 2 so that the display part 1 is directed to the retracted position, in order to retract the display part 1 up to the retracted position. Then, using the spherical body 22 of the arm part 2 as a center, the user rotates the forward end of the arm part 2 along the second guide groove portion 832.

During the image viewing, the arm part 2 is placed on the first guide groove portion 831, as described above. Upon receipt of the force from the user, the arm part 2 slides along the first guide groove portion 831, and moves the display part 1 in the direction away from the position of the user's eye (in the direction indicated by the arrow A in FIG. 10). When the arm part 2 reaches the end of the first guide groove portion 831, the arm part 2 slide along the second guide groove portion 832, rotates the display part 1 in the direction of the head mounted part 5 (in the direction indicated by the arrow B in FIG. 10), thereby guiding the display part 1 to the retracted position.

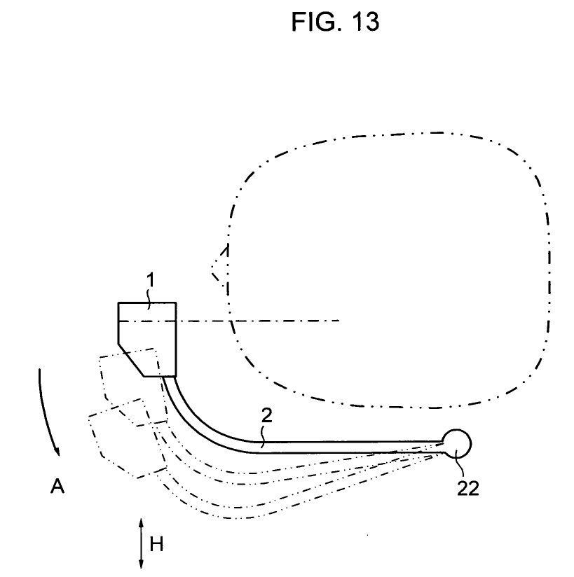

FIG. 13 illustrates an image indicating a positional relationship between the movement of the display part 1 and the head of the user, when the arm part 2 rotates about the spherical body 22 of the arm part, while guided by the first guide groove portion 831.

According to the head mounted display 20 of the present embodiment, when the user finishes viewing the image and retracts the display part 1 together with the arm part 2 to the retracted position, the guide groove 83 restricts the movement of the arm part 2 as described above. Therefore, the movement of the display part 1 which is installed on the forward end of the arm part 2 is also restricted. When the user finishes viewing the image and retracts the arm part 2 and the display part 1 up to the overhead location, the display part 1 is once moved outwardly from the usage position in the user's face width direction H, and thereafter, the display part is rotated to the retracted position. Therefore, this movement reduces the likelihood that the display part 1 touches the user's face area such as the forehead and hair. Accordingly, the possibility of smudging or damaging the display part 1 upon retraction is reduced.

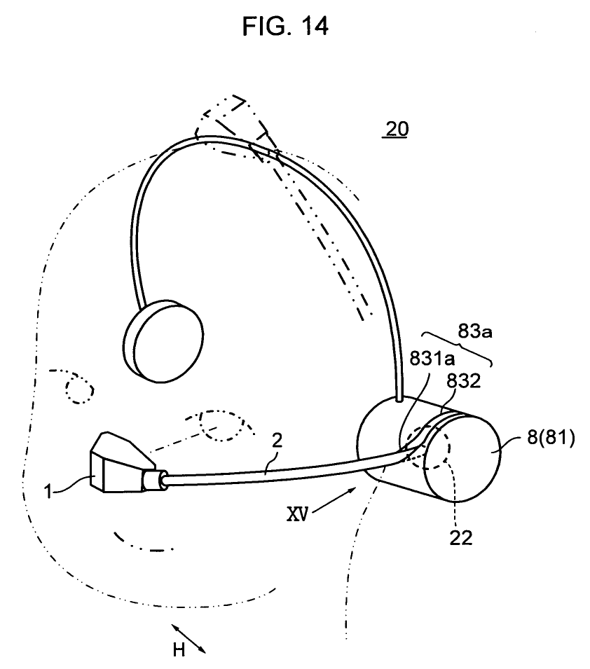

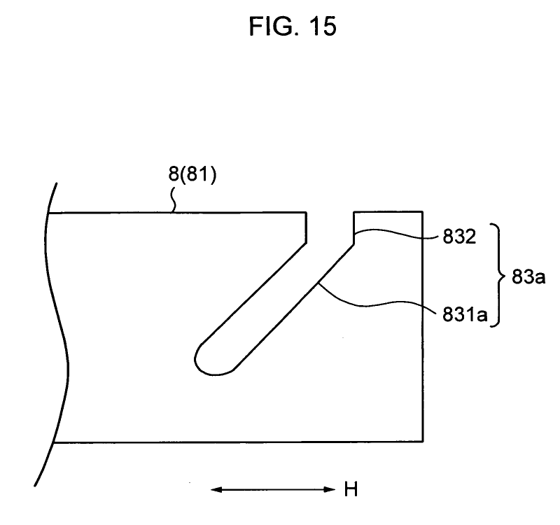

It is to be noted that the shape of the first guide groove portion 831 of the guide groove 83 is not limited to the aforementioned shape. FIG. 14 illustrates a modified example showing the shape of the guide groove 83a. FIG. 14 is a perspective view of the head mounted display according to the modified example. FIG. 15 is an illustration of the installation part 8 viewed from the arrow XV in FIG. 14. As is shown in these figures, the first guide groove portion 831a of the guide groove 83a not necessarily extends in the direction parallel to the face width direction H, but it is further possible to extend in other direction including a directional element of the face width direction H.

In the examples described above, a bottomless cam groove being a through-type is shown, but the present invention is not limited to this form. For example, as shown in FIG. 16, it is further possible to use a cam groove having a bottom 44. In this case, it is further possible to configure such that the signal line 71 goes through the support part 3 from the arm part 2.

Also in the modified example, when the user finishes viewing the image and retracts the display part 1 together with the arm part 2 to the retracted position, the movement of the arm part 2 is restricted by the guide groove 83a. Therefore, the movement of the display part 1 installed on the forward end of the arm part 2 is also restricted by the guide groove 83a. When the user finishes viewing the image and retracts the arm part 2 and the display part 1 up to the overhead location, the display part 1 rotates directed to the retracted position, while moving outwardly from the usage position in the user's face width direction H. Therefore, the likelihood that the display part 1 touches the user's face, such as the forehead and hair, is reduced. Accordingly, it is also less possible that the display part 1 becomes smudged or damaged upon retraction.

It is to be noted here that each of the embodiments of the present invention is directed to the head mounted display of a type for viewing an image with one eye. However, the present invention may be applied to a head mounted display of a type for viewing an image with both eyes.

1. A head mounted display comprising a head mounted part wearable on a head, an arm part having a display part installed on one end, an installation part for installing the other end of the arm part rotatably relative to the head mounted part, wherein,
the installation part installs the other end of the arm part in such a manner that the one end of the arm part is subjected to displacement, in the direction getting away from the installation part, or in the direction getting away from a user's eye position in the user's face width direction.

2. The head mounted display according to claim 1, wherein,
the installation part installs the other end of the arm part on the head mounted part, in such a manner that after the one end of the arm part is subjected to the displacement in the direction getting away, the arm part performs rotation relative to the head mounted part, so as to retract the display part up to a position opposed to the head mounted part.

3. The head mounted display according to claim 1, wherein,
the installation part installs the other end of the arm part on the head mounted part, in such a manner that the one end of the arm part performs the rotation, while subjected to the displacement in the direction getting away, so as to retract the display part up to a position opposed to the head mounted part.

4. The head mounted display according to claim 1, wherein,
the installation part installs the other end of the arm part on the head mounted part, in such a manner that after the one end of the arm part is subjected to the displacement in the direction getting away from the position of the user's eye in the face width direction of the user, the arm part performs the rotation relative to the head mounted part, so as to retract the display part up to a position opposed to the head mounted part.

5. The head mounted display according to claim 2, wherein,
a cam follower is formed on the other end side of the arm part, and
the installation part has a cam being formed therein to be engaged with the cam follower for guiding the displacement and the rotation.

6. The head mounted display according to claim 1, comprising a sensor for detecting a predetermined motion of the arm part and outputting a signal for turning off the head mounted display power supply, wherein,
the sensor outputs the signal when the sensor detects that the arm part displaces the display part in the direction getting away from the installation part, or in the direction getting away from the user's eye position in the user's face width direction.

7. The head mounted display according to claim 1, wherein,
the rotation and the displacement of the arm part are performed to be symmetric with respect to a plane defined by the head mounted part.
